(19) United States
(12) Patent Application Publication
(10) Pub. No.: US 2018/0354764 A1
(43) Pub. Date: Dec. 13, 2018

(54) APPARATUS AND METHOD FOR FILLING AND SEALING CONTAINERS

(71) Applicant: NESTEC S.A., Vevey (CH)

(72) Inventors: Andrea Comin, Vittel (FR); Damien Kannengiesser, Golbey (FR)

(73) Assignee: NESTEC S.A., Vevey (CH)

(21) Appl. No.: 15/781,331

(22) PCT Filed: Dec. 6, 2016
(86) PCT No.: PCT/EP2016/079960

§ 371 Date: Jun. 4, 2018

(30) Foreign Application Priority Data
Dec. 7, 2015 (EP) 15198157.8

(51) Int. Cl. B67B 3/20; B67C 7/00

(52) U.S. Cl. CPC B67B 3/2033; B67C 7/0053; B67C 2007/0066; B67C 2007/006; B67B 3/2066

(57) ABSTRACT

An apparatus (100) for filling and sealing containers comprises a carousel (401) with a plurality of stations (106) revolving about an axis (104), each station (106) comprising a holder (108) adapted to accommodate a container (110), a filling tool (126) for dispensing a fluid product in the container, and a sealing tool (200) for applying a closure (202) to the container (110); at each station (106), the holder (108) is mobile in a radial direction (R) of the carousel between a first, retracted position substantially aligned with the filling tool (126), and a second, extended position substantially aligned with the sealing tool (200).

### FIELD OF THE INVENTION

The present invention concerns an apparatus for producing filled containers. More specifically, the invention concerns an apparatus integrating both a filling and a sealing capability, as well as an installation comprising such an apparatus, and a method of its use.

### BACKGROUND OF THE INVENTION

In the art of manufacturing and materials-handling equipment, it is widely known to base apparatuses for the manipulation of products on the principle of a carousel. One category of such encompasses carousel-based apparatuses for filling containers on a container-production line.

In such an apparatus, a number of container-retaining stations are disposed so as to revolve about a central axis, thereby constituting the wheel-like structure generally referred to as a carousel.

From the perspective of each station, the operation of the apparatus is cyclical, repeating with each rotation of the carousel. The exact phases of the operation will vary according to the task that the apparatus is designed to achieve, but in general there are four phases that can be identified.

First, a container is loaded into an empty station, for instance from a transfer wheel or a linear conveyor, at an initial angular position of the carousel. Subsequently, as the container revolves with the carousel, a tool device configured to move synchronously with the carousel performs an operation on the container, generally accounting for a substantial portion of a rotation of the carousel. The filling completed, the container is next extracted from the holder, to be conducted off by e.g. another transfer wheel or conveyor. Finally, the holder will continue to rotate, returning to the initial angular position such that the cycle can be repeated with another container.

In most implementations, the carousel will comprise a number of holders and tools, multiplying the output of the apparatus proportionally.

This is advantageous in that it simplifies the configuration of the apparatus when it is to be implemented in a continuous-production installation. Rather than configuring the tool(s) of the apparatus to move linearly with a production line which complicates the installation of structures such as fluid feed pipes, hydraulic/pneumatic systems, motion control systems, etc.—the tool(s) of the apparatus rotate with the carousel.

This greatly simplifies the design and configuration of the apparatus when installed in an industrial setting, in that the apparatus and its appurtenant systems can be designed around a simple uniaxial rotation rather than linear motion which may be quite complex. The continuous nature of such an apparatus also permits a greater output than a simple batch-process operation.

However, such apparatuses are problematic when part of a larger continuous-production operation. Specifically, integrating filling and capping apparatuses into a production line will also necessitate several transfer wheels to move the filled containers from the filling carousel to the sealing carousel. Each time the container moves onto or off of a transfer wheel, the centrifugal forces present will abruptly reverse direction. This can cause the fluid within the filled but unsealed containers to slosh about, foam, and possibly spill from the containers, negatively impacting the cleanliness and accuracy of the filling operation as a result.

In addition, such carousel-type apparatuses often require a great deal of floor space to install in a factory, particularly at high capacities. In particular, spatial constraints may make it such that the size of the carousel, and by extension the throughput of the production line, must be limited. Such a situation is particularly aggravated when there are several carousel-type apparatuses which must be accommodated in a particular space, as well as transfer wheels, conveyor belts, and other appurtenant devices.

There is thus a need for an apparatus that resolves at least some of these inconveniences and disadvantages.

### SUMMARY OF THE INVENTION

To this end, the invention is directed towards an apparatus for filling and sealing containers, comprising a carousel constituted by a plurality of stations revolving about an axis, each of said stations comprising a holder adapted to accommodate a container disposed therein; a filling tool adapted to cooperate with said container and dispense a quantity of a fluid product therein; and a sealing tool adapted to apply a closure to said container.

According to a first aspect, at each station said holder is mobile in a radial direction of said carousel between a first retracted position wherein said holder is substantially aligned with said filling tool; and a second, extended position wherein said holder is substantially aligned with said sealing tool.

This is advantageous in that, as the filling and sealing functions are carried out on a single carousel-based apparatus, the fluid disposed within the containers is subjected to a limited amount of disturbance.

More particularly, the apparatus avoids the necessity of providing a plurality of transfer wheels or other such apparatuses for moving the filled but unsealed containers between the filling tool and the sealing tool. By providing both the filling tool and the sealing tool in the form of a single-carousel apparatus, the filled but unsealed containers are subjected to a constant centrifugal force, thereby reducing splashing, frothing, and other undesired effects on the fluid disposed within the container.

Moreover, the transfer between the first, retracted position at which the container is filled, and the second, extended position at which the container is sealed, is accomplished by displacing the holder radially outwards, thereby minimizing the acceleration of the container during the transfer. This is in contrast to a conventional transfer, where the accelerations encountered by the container upon transfer can be quite abrupt.

As a result, the filling and sealing of the container are performed with a minimum of spillage, thereby reducing product wastage and improving the cleanliness and accuracy of the apparatus.

Also, such an apparatus is advantageous in that, the filling and sealing actions being combined in one apparatus, it requires less physical space than would be required for separate filling and sealing apparatuses and the appurtenant transfer wheels and other mechanisms.

In a preferred embodiment, the apparatus further comprises a contoured rail, the form of said contoured rail substantially corresponding to the displacement of each of the plurality of holders over a single rotation of the carousel; and a plurality of followers configured to engage said contoured rail and displace accordingly a corresponding one of said plurality of holders.

In this way the radial and axial displacement of each of the holders is synchronized with its revolution about the axis of the carousel, such that the holder will move, and the container be engaged by the filling and sealing tools, at precisely the correct rotational position of the carousel. The control and construction of the apparatus is thereby simplified, as the motions of many of the elements thereof are keyed off of the rotation of the carousel.

Most preferably, the follower of each station comprises a mechanical linkage.

An apparatus so configured will therefore require no additional electrical or computer controls to effectuate the translational movements of the holder over the course of a revolution.

In a possible embodiment, the holders are disposed about the axis of the carousel at substantially uniform angular intervals.

This is advantageous in that the filling and sealing of the containers is repeated at regular, predictable intervals as the carousel rotates. The rate at which empty containers, product fluid, etc. must be fed to the apparatus, as well as the output of filled, sealed containers, is thereby made more constant and predictable.

Advantageously, each of the holders further comprises a gripper configured to selectively grasp a container.

This is advantageous in that, as the gripper retains the container in the holder when engaged, the containers are less likely to become misaligned or dislodged from the holders as the grippers offer a greater resistance to the forces generated by the rotation of the carousel and the weight of the containers. The apparatus may therefore be utilized in a wider range of parameters, e.g. with larger, heavier containers, irregularly-shaped containers, faster rotational speed, etc. than might otherwise be practical.

In a possible embodiment, the sealing tool is configured to apply a cap to the container.

This is advantageous in that caps, and in particular screw-on caps, are a standard closure for beverage containers; the apparatus is thereby adapted to apply closures which are commonly known in the art and of standardized construction and characteristics.

According to a second aspect, there is provided an installation for filling and sealing containers, comprising an apparatus as described above, a container-feeding means for providing a plurality of empty containers to the apparatus, and a container-removing means for conducting filled and sealed containers from the apparatus.

This is advantageous in that it realizes the advantages of the apparatus as described above, in a continuous production-line context.

Preferably, the installation further comprises a cap-loading apparatus configured to load a cap into each of the plurality of sealing tools.

In this way, the containers are advantageously sealed with caps, which is advantageous as discussed above.

In a preferable embodiment, the container-feeding and container-removing means are transfer wheels.

This is advantageous in that, by using transfer wheels to load and unload containers from the carousel, the apparatus is easily integrated into existing installations employing known means for conducting containers along the production line.

According to a third aspect, there is provided a method for filling and sealing a container, comprising the steps of providing an apparatus as described above, the carousel of said apparatus revolving at a substantially constant speed; inserting a container into one of the plurality of holders; positioning said holder in a first, retracted position; placing the filling tool in fluid communication with said container and dispensing a quantity of fluid therein; positioning said holder in a second, extended position; sealing said container with the sealing tool; and extracting said container from the apparatus.

This is advantageous in that it will fill and seal containers in a way that realizes the advantages of the invention as described above, in particular with a reduced degree of spillage or other disturbance to the fluid product prior to the sealing of the containers.

Preferably, the steps of the method are executed during one rotation of the carousel.

This is advantageous in that the container loaded into the holder will be filled and extracted by the time the holder reaches its initial position. The apparatus will thereby produce one filled container per station per rotation, maximizing its output and efficiency.

Alternatively, the steps of the method are executed over several rotations of the carousel.

In this way, a lengthened time for the filling and sealing steps is realized.

In a possible embodiment, the method further comprises a step for loading the sealing tool with a closure prior to the step for sealing the container.

In this manner, the sealing step is most rapidly and efficiently executed when the seal is formed by a separate sealing element applied by the sealing tool, such as a cap or plug.

In a possible embodiment, during the step for inserting a container a gripper is closed on said container so as to retain it in place within the holder, and wherein during the step for extracting said container said gripper is opened.

This is advantageous in that, since the gripper holds the container in place in the holder as discussed above, the carousel may be rotated and the method performed more rapidly than may be possible if the container were merely resting on or in the holder. In this way, the output of the method is improved.

Preferably, the method is repeated at each station of the carousel.

In this way, the apparatus will maintain a continuous output of filled and sealed containers, the time necessary to perform the method on each individual container notwithstanding.

According to a fourth aspect, the invention is drawn to a filled and sealed container produced by the method as described above.

This is advantageous in that such a container embodies the advantages of the apparatus and method employed in its production, as discussed above with respect to other aspects of the invention.

### BRIEF DESCRIPTION OF THE DRAWINGS

Additional features and advantages of the present invention are described in, and will be apparent from, the description of the presently preferred embodiments which are set out below with reference to the drawings in which:

FIGS. 1 and 2 are side views of an exemplary station of a container filling and sealing apparatus, respectively in a first, retracted and a second, extended position;

FIG. 3 is a schematic depiction of a method for filling and sealing a container with a carousel comprising the station of FIGS. 1A and 1B; and

FIG. 4 is a schematic depiction of the apparatus of FIGS. 1A and 1B, as integrated into a production line.

### DETAILED DESCRIPTION OF THE INVENTION

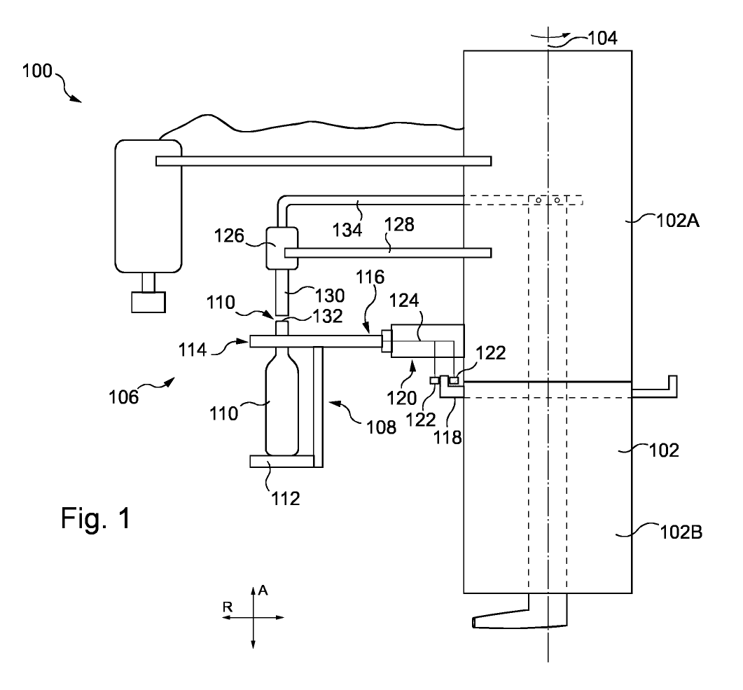

The invention will first be discussed with relation to FIG. 1, which depicts an apparatus 100 for filling and sealing containers. The apparatus 100 comprises a central spindle 102, which rotates about an axis 104 at an upper portion 102A and is stationary at a lower portion 102B.

The apparatus 100 comprises further a plurality of stations 106. The station 106 comprises a holder 108, which is configured to hold a container 110 in place.

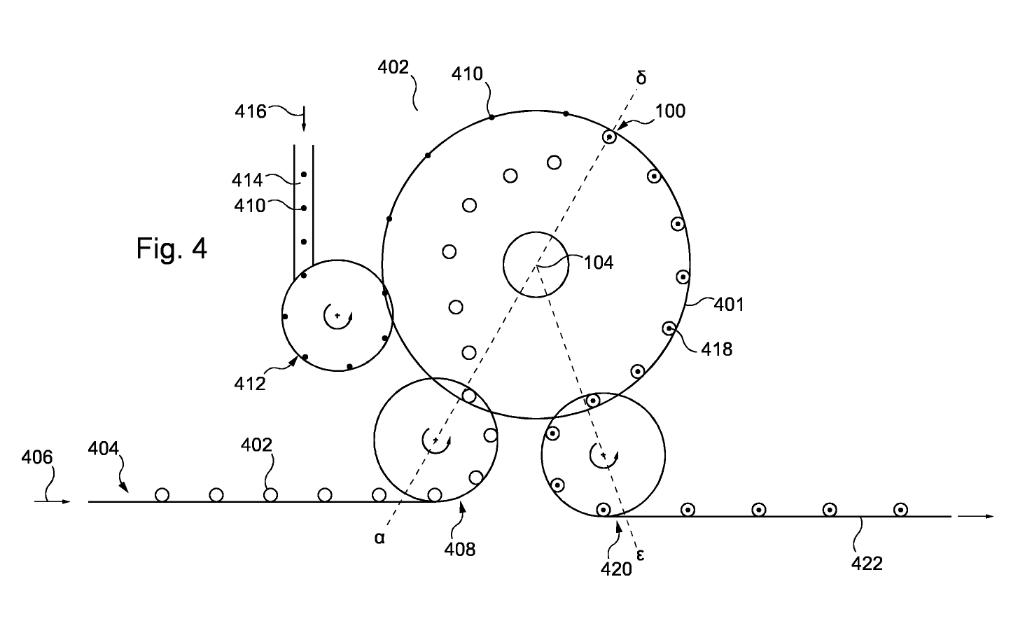

It will be apparent that only one station 106 is here depicted, for purposes of clarity. In an actual installation of the apparatus 100, there would be a number of stations 106 extending from the central spindle 102, preferably equally spaced, so as to thereby form a structure commonly known and referred to as a “carousel.” The carousel rotates about the axis 104, and each of the stations 106 acts as described in the following description, merely with a phase offset relative to each of the other stations 106; this action is also illustrated in FIG. 4, discussed below. In this way, the apparatus 100 intakes empty, open containers and outputs filled, sealed containers at a substantially constant rate.

More specifically, the holder 108 is constituted by a shelf 112 and a gripper 114. The shelf 112 serves to support the weight of the container 110 (particularly once filled with product), while the gripper 114 holds the container 110 at the neck thereof so as to maintain it in position and keep it from being spilled. The shelf 112 can take any form providing the required supporting function and the gripper 114 can take the form of a fork for holding the container or any other form providing the same function.

Alternatively, the gripper 114 can combine these two functions into one unit, holding the container 110 in position and supporting its weight. For example, the gripper 114 may be configured to support the container 110 by engaging a neck ring such as are commonly found on beverage containers known in the art.

The gripper 114 is, as its name suggests, configured to grasp the container 110 by the application of a force that is selectively applied. This may be furnished by a mechanical linkage driven by the rotation of the carousel, or by independently-controlled means such as a linear or stepper motor, or a pneumatic or hydraulic actuator. The person of skill in the art will understand the advantages and disadvantages of each and their appropriateness for any given situation.

It will also be recognized, however, that in the embodiment depicted here the configuration of the station with regard to the structure for holding the container 110 in place may vary from installation to installation, depending on such factors as e.g. the size of the container, the density and volume of fluid with which it is filled, the speed at which the filling and sealing process is performed, etc. Thus, it should be understood that the holder of any particular implementation may vary with respect to the holder 108 depicted here in the Figures.

The holder 108 may optionally be furnished with a scale, either in the gripper 114 so as to measure the weight of the container. This may be advantageous in certain implementations of the invention, in that it allows for accurate weighing of the container, and by extension accurate portioning of the fluid product, during the filling thereof.

The holder 108 and shelf 112 are attached to the central spindle 102 by means of a holder arm 116, which extends from the central spindle 102 in the radial direction R, thereby maintaining the holder 108 at a distance from the central spindle 102. The holder arm 116 is also extensible in the radial direction R, such that the distance of the holder 108, and by extension the container 110, from the central spindle 102 can be adjusted.

In the embodiment depicted here in FIG. 1, the holder arm 116 achieves this extensibility by virtue of its being configured as a telescopic member. Other configurations, such as a scissors-type or piston mechanism, may equally be envisioned.

The extension and retraction of the holder arm 116 may be governed by various means. In certain implementations, the extension and retraction may be effectuated by a pneumatic or hydraulic cylinder; in others, electrical means such as a stepper motor may be preferable. In still other implementations, a mechanical means, such as a cam, may be implemented.

To this end, in the embodiment depicted in FIG. 1 there is provided a contoured rail 118, shown here in section, which extends from the central spindle 102. The holder arm 116 is provided with a follower mechanism 120, comprising two follower wheels 122 and a follower linkage 124.

The contoured rail 118 wraps about the entire circumference of the central spindle 102, and is shaped such that its contour is proportionate to the motion of the holder over the course of one iteration of a container filling and sealing cycle. The operation of this is similar to the principle employed in a so-called “face cam,” and in other, related mechanical devices.

While the holder arm 116 and follower mechanism 120 are configured to rotate with the upper portion 102A of the central spindle 102, the contoured rail 118 extends from the stationary lower portion 102B and is thus stationary itself. As the follower wheels 122 follow the contoured rail 118, the holder arm 116 will be induced to extend and retract in the radial direction R.

Thus, the position of the holder arm 116 and the container 110 is a function of the contour of the contoured rail 118. By varying the contour of the contoured rail 118 over the circumference of the central spindle 102, the position of the holder arm 116 is made a function of its rotational position about the axis 104. By extension, when the speed of rotation of the central spindle 102 is known, the speed and acceleration of the holder 108 at a given point of the rotation of the carousel are also known.

Of course, it will be understood that, depending on the particular aspects of the implementation in question, other means for synchronizing the motion of the holder 108 in the radial direction R with its rotation about the axis 104 may be envisioned.

For instance, there may be provided a recessed slot, rather than a protruding rail, which is tracked by a follower linked to the holder arm 116. Alternatively, the extension and retraction of the holder arm may be generated by a camshaft and mechanical linkage disposed within the central spindle 102.

In any event, the person of skill in the art will recognize that, when mechanical means are used to govern the position of the holder 108 as a function of the angular position of the station 106, any number of different configurations may be possible, depending on the attributes and limitations of the particular implementation in question, and the structure disclosed in the present application should be considered as exemplary and non-limiting.

Returning to FIG. 1, the station 106 is further provided with a filling tool 126, which extends from the upper portion 102A of the central spindle 102 by way of a filling arm 128. The filling tool 126 further comprises a nozzle 130, which is configured to cooperate with a mouth 132 of the container 110.

In many embodiments, the filling tool 126 comprises a filling valve (not shown), which controls the flow of fluid through the nozzle 130. Integrating this valve into the filling tool 126 is particularly advantageous in that it reduces the “dead volume” of the filling tool 126, i.e. the volume between the valve and the nozzle 130. However, it may be equally feasible to dispose the metering and dosing equipment elsewhere in the apparatus 100.

In any event, the actuation of the filling tool 126, and thus the dispensing of a product fluid (not shown) into the container 110, will be dependent on the radial position of the station 106, in that the filling tool 126 should not dispense the product fluid unless and until there is a container 110 present to receive it.

Thus, during the operation of the apparatus 100, to fill the container 110 the holder 108 is displaced by the action of the follower mechanism 120 on the contoured rail 118 into the first, retracted position as depicted in FIG. 1. In this first, retracted position, the holder arm 116 is substantially retracted; the holder 108 is consequently positioned such that the container 110 held therein is aligned with the nozzle 130 of the filling tool 126.

Optionally, the filling tool 126 may be made mobile in the axial direction A, so as to engage the container 110 once positioned, thereby preventing spillage during a filling step. This may be achieved by conventional means, such as e.g. pneumatic, hydraulic, or electrical actuators, or by a mechanical linkage as with the holder 108.

In any event, however, once the holder 108 is put into the desired alignment, the container 110 is filled. To this end, the filling tool 126 may be fed by supply lines 134, which connect the filling tool 126 to a source of product fluid (not shown).

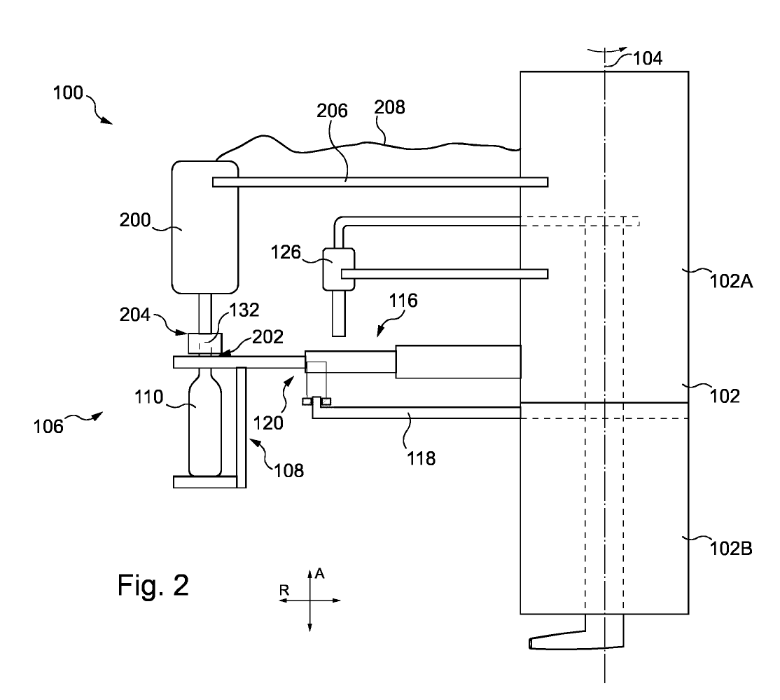

Turning now to FIG. 2, the apparatus 100 is depicted in a subsequent step for sealing the container 110, now filled with a fluid product.

As the upper portion 102A of the central spindle 102 has rotated, the portion of the contoured rail 118 upon which the following mechanism 120 rides has moved outwards in the radial direction R. As a result, the following mechanism 120 has extended the holder arm 116, causing the holder 108 to move radially outward and displace the container 110 held therein as a result.

The holder 108 has thus been moved into a second, extended position. This causes the mouth 132 of the container 110 to align with a sealing tool 200.

In the embodiment depicted here, the sealing tool 200 is configured to screw a cap 202 to the mouth 132 of the container 100. To this end, it comprises a socket 204, in which the cap 202 is held prior to the holder 108 being moved into the second, extended position.

The sealing tool 200 is essentially an electric motor, mounted on the central spindle 102 at a fixed distance by a sealing arm 206. As with the filling tool 126 the sealing tool 200 is fed from a power source (not shown) through an electric power line 208; alternative embodiments may employ other motive means such as mechanical driveshafts and/or pulleys, hydraulic or pneumatic motors, or some combination thereof. The activation of the sealing tool 200 is, like the filling tool 126, triggered by the radial position of the station 106 as the apparatus 100 rotates about the axis 104.

When the holder 108 is moved into the second, extended position as shown, the sealing tool 200 is displaced along the axis A to engage the cap 202 with the mouth 132 of the container 110; at this point, the sealing tool 200 rotates the socket 204, thereby screwing down the cap 202 and sealing the container.

Of course, it may be possible that other means of sealing the container are employed, in which case the configuration of the sealing tool and the motion thereof in the axial direction A and radial direction R, may vary.

In particular, it may be envisioned to seal the container by thermal or ultrasonic welding, application of an adhesive membrane, or other such methods as are known and commonly employed in the packaging arts. Alternatively, sealing means such as a crown cork, metal foil, crimp, or the like may also be envisioned, and may be readily adapted to be used in an apparatus according to the present invention.

Furthermore, it may also be desirable to provide an apparatus where the holder itself is mobile in the axial direction A, with the filling and sealing tools remaining stationary.

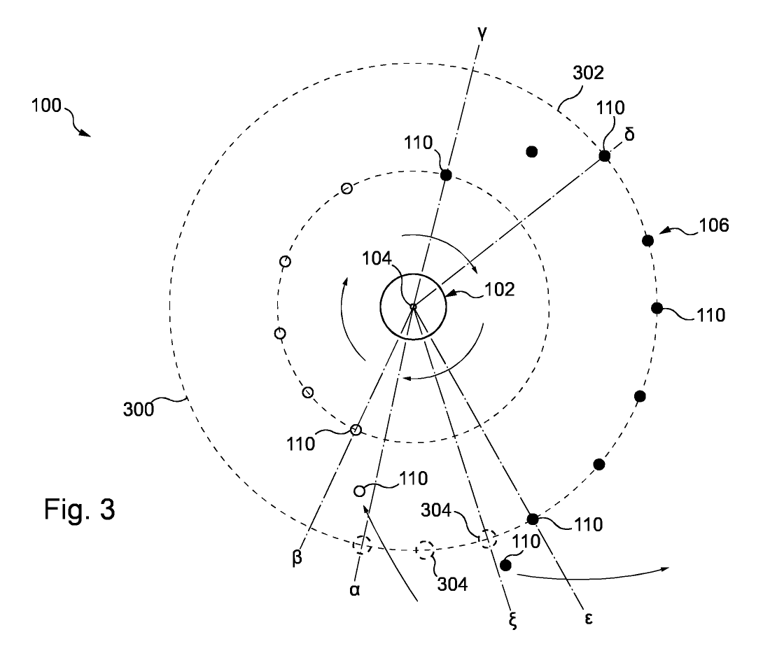

Turning now to FIG. 3, the cycle of operation of the apparatus 100 will be discussed in greater detail.

FIG. 3 is a schematic depiction of the operation of the apparatus 100. More specifically, FIG. 3 is a depiction of a single station 106 of the apparatus 100 at a plurality of angular positions as it rotates about the axis 104. In this way, the trajectory of the container 110 through the filling and sealing process is illustrated.

The container 110 is loaded into the apparatus between the angular positions α and β during a loading phase. The duration of the loading phase will depend on the configuration of the apparatus (in particular that of the holder and the container), but in any event will need to be long enough for the container 110 to be inserted into the holder and be correctly positioned therein.

It will also be noted that the container 110 is positioned into a first, retracted position 300, demarcated here by a dashed-line circle. The holder is thus placed in the correct position for the filling of the container 110, as described above with reference to FIGS. 1A and 1B, as the container 110 is aligned with the filling tool.

Between the angular positions β and γ the container 111 is filled with the fluid product. As the speed of rotation about the axis 104 and the axial position of the holder are constant, the container 110 will be subjected to a minimum of disturbance; this serves to minimize splashing and foaming of the fluid product.

At the angular position γ, the filling process has been completed, at which point the holder is displaced to put the container into the second, extended position 302. This displacement occurs over the angular interval between angular positions γ and δ.

It is preferable that the holder be displaced outward after the filling of the container 110, rather than inward, as the acceleration experienced by the container 110 will be in the same direction as the centrifugal force exerted on it by the apparatus, rather than opposite it. This reduces splashing generated by the motion of the containers and facilitates their extraction by a transfer wheel or the like.

At angular position δ, the step for sealing the container 110 is commenced, continuing over the interval from angular position δ to angular position ε. As mentioned above, the sealing step may involve the screwing-on of a cap, thermal- or ultrasonic welding, attaching a cap with adhesive or mechanical means, or other such sealing methods or combination of methods.

At angular position ε, the container 110 is sealed, and ready to be extracted from the apparatus 100. The extraction step occurs over the angular interval between angular position ε and angular position ζ, wherein the container 110 is extracted from the holder and borne off to a subsequent step in the production line, e.g. shipment.

The holder, however, will remain at a second, extended position 302, illustrated here by a container outline 304, so as to be ready to receive a new container 110 for a subsequent iteration of the process, as the station moves to the angular position α.

It should be noted, however, that in alternate embodiments, it may be preferable to execute the filling and sealing process over multiple rotations of the carousel. Such a configuration is particularly useful when the filling or sealing processes must be executed over a longer period of time than would be feasible by simply slowing down the rotation of the carousel. For instance, it may be necessary or preferable to dispense particularly viscous fluid products at a slower rate than for less viscous products.

For instance, the method may be performed over two rotations of the carousel. In such an embodiment, the containers are loaded into every other holder passing between angular position α and angular position β, and the containers so loaded will pass between angular position ε and angular position ζ once before being extracted.

Indeed, by independently controlling the displacement of the holder at each station and adapting the rate at which the containers are loaded, the containers may be retained on the apparatus for several rotations before being extracted, thereby maximizing the compatibility of the apparatus with respect to the products it can be employed to package and the methods by which it can package them.

Finally, turning now to FIG. 4, the integration of the apparatus 100 into an installation 400 is illustrated.

The installation 400 comprises the apparatus 100, as described with reference to the preceding figures. As mentioned above, the apparatus 100 comprises a number of stations extending from the axis 104 and collectively forming a carousel 401. As all of the stations are mounted at essentially the same distance from the axis 104, the carousel 401 is round in shape, and is represented here symbolically by a substantially circular form.

A supply of empty containers 402 arrive through a container feeder 404, which is supplied by a container source 406 feeding a steady supply of the empty containers 402.

The empty containers 402 are picked up by a first transfer wheel 408. The first transfer wheel 408 rotates to transfer the empty containers 402 from the container feeder 404 to the first angular position α, where the empty container 402 is transferred to the holder of a coincident station of the apparatus 100.

At the same time, there is provided a means for feeding a supply of closures 410 into the apparatus 100. A closure feed wheel 412 receives the closures 410 from a closure feed 414, itself fed by a closure source 416 in the same manner as the first transfer wheel 408 is fed with the empty containers 402.

The closure feed wheel 412 serves to load the closures 410 into each of the sealing tools of the apparatus 100 as said sealing tools pass. The closures 410 continue along, loaded in their respective sealing tools, until they reach the angular position δ, at which point the sealing step is performed as described above.

In this way, the sealing tools of the apparatus 100 are prepared to begin the step for sealing the containers 402 as soon as their respective stations are brought into the second, extended position.

As discussed above, the sealing step occurs between the angular positions δ and ε, illustrated here by a plurality of sealed containers 418; at exactly which angular position the container is sealed will depend on the type of closure used, the size and shape of the container, and possibly other factors, but the sealing will in any event be completed between these two angular positions.

The sealed containers 418 continue until they reach the angular position ε, wherein they are removed from the apparatus 100 by a second transfer wheel 420. The second transfer wheel 420 disposes the sealed containers 418 into an exit chute 422, which conducts the sealed containers 418 off for subsequent processing and shipment.

It should be understood that various changes and modifications to the presently preferred embodiments described herein will be apparent to those skilled in the art.

Such changes and modifications can be made without departing from the spirit and scope of the present invention and without diminishing its attendant advantages. It is therefore intended that such changes and modifications be covered by the appended claims.

1. An apparatus for filling and sealing containers, comprising a carousel comprising a plurality of stations revolving about an axis of the carousel, each of the stations comprising:
a holder adapted to accommodate a container positioned therein;
a filling tool adapted to cooperate with the container and dispense a quantity of a fluid product therein; and
a sealing tool adapted to apply a closure, to the container;
at each station, the holder is mobile in a radial direction of the carousel between a first, retracted position wherein the holder is substantially aligned with the filling tool; and a second, extended position wherein the holder is substantially aligned with the sealing tool.

2. The apparatus according to claim 1, further comprising a contoured rail, the contour of the contoured rail substantially corresponding to the displacement of each of the plurality of holders over a single rotation of the carousel, each of the plurality of holders further comprising a follower configured to engage the contoured rail and displace accordingly the corresponding one of the holders.

3. The apparatus according to claim 2, wherein the follower of each station comprises a mechanical linkage.

4. The apparatus according to claim 1, wherein the holders are positioned about the axis of the carousel at substantially uniform angular intervals.

5. The apparatus according to claim 1, wherein each of the holders further comprises a gripper configured to selectively grasp a container.

6. The apparatus according to claim 1, wherein the sealing tool is configured to apply a cap to the container.

7. An installation for filling and sealing containers, comprising: an apparatus for filling and sealing containers, comprising a carousel comprising a plurality of stations revolving about an axis of the carousel, each of the stations comprising a holder adapted to accommodate a container positioned therein, a filling tool adapted to cooperate with the container and dispense a quantity of a fluid product therein, and a sealing tool adapted to apply a closure to the container; at each station, the holder is mobile in a radial direction of the carousel between a first, retracted position wherein the holder is substantially aligned with the filling tool, and a second, extended position wherein the holder is substantially aligned with the sealing tool; a container-feeder for providing a plurality of empty containers to the apparatus; and a container-remover for conducting filled and sealed containers from the apparatus.

8. The installation according to claim 7, further comprising a cap-loading apparatus configured to load a cap into each of the plurality of sealing tools.

9. The installation according to claim 7, wherein the container-feeder and container-remover are transfer wheels.

10. A method for filling and sealing a container, comprising the steps of:
providing an apparatus for filling and sealing containers, comprising a carousel comprising a plurality of stations revolving about an axis of the carousel, each of the stations comprising a holder adapted to accommodate a container positioned therein, a filling tool adapted to cooperate with the container and dispense a quantity of a fluid product therein, and a sealing tool adapted to apply a closure to the container; at each station, the holder is mobile in a radial direction of the carousel between a first, retracted position wherein the holder is substantially aligned with the filling tool, and a second, extended position wherein the holder is substantially aligned with the sealing tool, the carousel of the apparatus revolving at a substantially constant speed;
inserting the container into one of the plurality of holders;
positioning the holder in a first, retracted position;
placing the filling tool in fluid communication with the container and dispensing a quantity of fluid therein;
positioning the holder in a second, extended position;
sealing the container with the sealing tool; and
extracting the container from the apparatus.

11. The method according to claim 10, wherein the steps of the method are executed over one rotation of the carousel.

12. The method according to claim 10, wherein the steps of the method are executed over several rotations of the carousel (401).

13. The method according to claim 10, comprising a step for loading the sealing tool with a closure prior to the step for sealing the container.

14. The method according to claim 10, wherein during the step for inserting a container a gripper is closed on the container so as to retain it in place within the holder, and wherein during the step for extracting the container the gripper is opened.

15. The method according to claim 10, wherein the method is repeated at each station of the carousel.

16. (canceled)
